(19) United States
(12) Patent Application Publication
(10) Pub. No.: US 2024/0333024 A1
(43) Pub. Date: Oct. 3, 2024

(54) INTEGRATED CIRCUIT WITH FAULT REPORTING STRUCTURE

(71) Applicant: Monolithic Power Systems, Inc., NE Kirkland, WA (US)

(72) Inventors: Ming LU, San Jose, CA (US); Pengjie LAI, San Jose, CA (US); Hang YANG, Chengdu (CN)

(21) Appl. No.: 18/738,372

(22) Filed: Jun. 10, 2024

Related U.S. Application Data
(63) Continuation-in-part of application No. 17/716,924, filed on Apr. 8, 2022, now Pat. No. 12,007,821.

(51) Int. Cl. H02J 9/06

(52) U.S. Cl. CPC H02J 9/06

(57) ABSTRACT

A power management integrated circuit (PMIC) chip for providing power loss protection to an application device. The PMIC chip may be adapted to co-work with a plurality sets of storage capacitors that are charged using power from a power source during normal operation. An application device receives power from the power source during normal operation and receives power from an operational set of storage capacitors during power loss. A failing set of storage capacitors is disconnected from an operational set of storage capacitors and from the PMIC chip. The operational set of storage capacitors remains connected to the PMIC chip to provide power loss protection.

### CROSS-REFERENCE TO RELATED APPLICATIONS

The present application claims priority as a continuation in part to U.S. patent application Ser. No. 17/716,924, filed on Apr. 8, 2022, which is incorporated herein by reference in its entirety.

### TECHNICAL FIELD

The present disclosure is directed to electrical circuits, and more particularly but not exclusively to power loss prevention circuits and associated integrated circuit (IC) devices.

### BACKGROUND

Power loss prevention (PLP) circuits are employed in applications where maintaining power to an application device is critical, such as in power backup systems, non-volatile Dual In-Line Memory Modules (NVDIMMs), solid state drives, hard disk drives, etc. A power management integrated circuit (PMIC) with PLP functionality, such as the MP5515 PMIC commercially-available from Monolithic Power Systems, Inc., has a single storage pin for connecting a set of storage capacitors, an input pin for receiving an input voltage from a power source, and an output pin for providing a bus voltage. The application device is powered by the bus voltage.

During normal operation, the PMIC provides power to the application device by connecting the power source at the input pin to the application device at the output pin. The PMIC also charges the storage capacitors during normal operation using power provided by the power source. In the event of power loss, the PMIC disconnects the power source and switches the storage capacitors to the output pin to provide the bus voltage. When a storage capacitor fails, a blocking transistor (e.g., metal-oxide semiconductor field-effect transistor (MOSFET)) is turned OFF to disconnect all of the storage capacitors from the PMIC, thereby preventing the resulting large inrush current from triggering over current protection and losing the bus voltage. This allows the PMIC to continue to provide the bus voltage from the power source even when a storage capacitor fails, albeit with no power loss protection.

### BRIEF SUMMARY

In one embodiment, an integrated circuit (IC) chip with power loss protection has an input pin that is adapted to receive an input voltage from a power source, an output pin that is adapted to provide a bus voltage to an application device. The IC chip may include a disconnect circuit and a controller in an example. The disconnect circuit may be coupled between the input pin and the output pin. The disconnect circuit may connect the input voltage at the input pin to the output pin in a normal operation when the power source provides the input voltage, and to disconnect the input pin from the output pin in an event of power loss when the power source no longer provides the input voltage. The controller may provide one or more driving signals adapted to operate a converter circuit to charge a plurality of sets of storage capacitors during the normal operation and to provide the bus voltage from energy stored in at least one operational set of storage capacitors of the plurality of sets of storage capacitors in the event of power loss.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a block diagram of a system with power loss protection in accordance with an embodiment of the present invention.

FIG. 2 shows a block diagram of a power management integrated circuit (PMIC) chip in accordance with an embodiment of the present invention.

FIG. 3 shows a schematic diagram of the PMIC of FIG. 2 in accordance with an embodiment of the present invention.

FIG. 4 shows a flow diagram of a method of providing power loss protection to an application device in accordance with an embodiment of the present invention.

FIG. 5 shows a block diagram of a system 500 with power loss protection in accordance with an embodiment of the present invention.

FIG. 6 shows a block diagram of the PMIC 510 in accordance with an embodiment of the present invention.

FIG. 7 shows a schematic diagram of the PMIC 510 in accordance with an embodiment of the present invention.

FIG. 8 shows a schematic diagram of the PMIC 510 in accordance with another embodiment of the present invention.

### DETAILED DESCRIPTION

In the present disclosure, numerous specific details are provided, such as examples of circuits, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

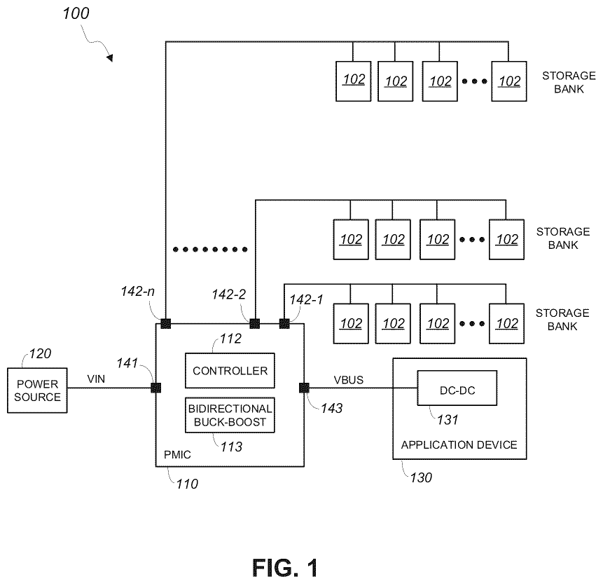

FIG. 1 shows a block diagram of a system 100 with power loss protection in accordance with an embodiment of the present invention. In the example of FIG. 1, the system 100 includes a power source 120, a power management integrated circuit (PMIC) 110, and an application device 130.

The power source 120 may comprise a power supply or other circuit for providing power to another circuit. In the example of FIG. 1, the power source 120 provides power in the form of an input voltage VIN, which is a DC voltage.

The application device 130 may comprise a power backup system, a non-volatile Dual In-Line Memory Module (NVDIMM), a solid state drive, a hard disk drive, or other device that benefits from power loss protection. For example, the application device 130 may include a volatile memory (e.g., random access memory (RAM)) having contents that need to be saved to a non-volatile memory (e.g., NVRAM) in the event of power loss. The application device 130 may include a DC-DC converter circuit 131, which is configured to generate and maintain a regulated output voltage from a bus voltage VBUS provided by the PMIC 110. The regulated output voltage of the DC-DC converter circuit 131 powers the circuits of the application device 130. The PMIC 110 maintains the bus voltage VBUS for a sufficient time in the event of a power loss when the power source 120 ceases to provide the input voltage VIN. As will be more apparent below, in the event of a power loss, the bus voltage VBUS is provided by the PMIC 110 from energy stored in a plurality of sets of storage capacitors 102 instead of from the power source 120.

As its name indicates, the PMIC 110 comprises electrical circuits that are packaged together as an integrated circuit (IC) chip. In the example of FIG. 1, the PMIC 110 includes a plurality of pins that includes an input pin 141, a plurality of storage pins 142 (i.e., 142-1, 142-2, . . . , 142-n), and an output pin 143. Pins that are not relevant to the present disclosure have been omitted in the interest of clarity.

The PMIC 110 receives the input voltage VIN from the power source 120 at the input pin 141. During normal operation, i.e., when the power source 120 provides the input voltage VIN, the PMIC 110 couples the input voltage VIN at the input pin 141 to the output pin 143 as the bus voltage VBUS. The bus voltage VBUS is a DC voltage. The DC-DC converter circuit 131 generates a regulated output voltage using the bus voltage VBUS as an input voltage. The DC-DC converter 131 may be a buck converter that steps down the bus voltage VBUS, a boost converter that steps up the bus voltage VBUS, or some other type of power converter.

Each single storage pin 142 is connected to an energy storage bank, which in one embodiment is a set of storage capacitors 102 that are connected in parallel. The PMIC 110, which has a plurality of storage pins 142, is connected to two or more energy storage banks. That is, the storage pin 142-1 may be connected to a first set of storage capacitors 102, the storage pin 142-2 may be connected to a second set of storage capacitors, etc. The PMIC 110 is configured to have at least two separate sets of storage capacitors 102, with each of the sets of storage capacitors 102 being separately connected to its own storage pin 142. Additional sets of storage capacitors 102, with each set being connected to a separate storage pin 142, may be connected to the PMIC 110 to meet specific application device requirements.

The PMIC 110 includes a power controller 112 and a bidirectional buck-boost converter 113. As its name indicates, the converter 113 is a DC-DC converter that operates as a buck converter in one direction or a boost converter in an opposite direction. During normal operation, the bidirectional buck-boost converter 113 uses the input voltage VIN from the power source 120 to charge the sets of storage capacitors 102 that are connected to the storage pins 142. In one embodiment, during normal operation, the bidirectional buck-boost converter 113 operates as a boost converter to step up the input voltage VIN to a higher voltage for charging the sets of storage capacitors 102. For example, the bidirectional buck-boost converter 113 may boost the input voltage VIN of 12V up to 30V, which is used to charge the sets of storage capacitors 102 during normal operation.

During power loss, the bidirectional buck-boost converter 113 operates as a buck converter that generates the bus voltage VBUS using energy stored in the sets of storage capacitors 102. For example, the bidirectional buck-boost converter 113 may buck the voltage provided by the sets of storage capacitors 102 from about 30V (which decreases as the energy stored in the sets of storage capacitors 102 is depleted) to about 10V, which is provided at the output pin 143 as the bus voltage VBUS. This allows the DC-DC converter circuit 131 to power the circuits of the application device 130 at least for a sufficient time to allow shutdown procedures to complete (e.g., saving to NVRAM) in the event of power loss. The length of time that the bus voltage VBUS can be provided by the PMIC 110 in the event of power loss depends on the energy storage capacity of the sets of storage capacitors 102.

As will be more apparent below, each set of storage capacitors 102 is connected to a separate blocking circuit. This allows a failed set of storage capacitors 102 to be disconnected from the PMIC 110 without impacting operational (i.e., nonfailing) sets of storage capacitors 102. For example, a failed storage capacitor 102 can create a short circuit to ground. By opening a corresponding blocking circuit, the set with the failed storage capacitor can be disconnected from the PMIC 110, and thus from operational sets of storage capacitors 102. This advantageously allows the PMIC 110 to continue to operate and provide some level of power loss protection, using stored energy from operational sets of storage capacitors 102 that are still connected to the PMIC 110, even in the event of a storage capacitor failure.

The PMIC 110 further includes the controller 112 for controlling the operation of the bidirectional buck-boost converter 113, a disconnect circuit, blocking circuits, and other components of the PMIC 110. The controller 112 may be configured to control the bidirectional buck-boost converter 113 by pulse width modulation (PWM) to operate in buck mode or boost mode operation using conventional algorithms. The controller 112 may generate control signals to control switching of transistors, etc. so that the PMIC 110 operates as described herein. The controller 112 may receive sense signals, such as sense currents/voltages to detect overcurrent, power loss, etc. The controller 112 may be configured to process and respond to received sense signals using comparators, state machines, logic circuits, etc. in accordance with conventional algorithms without detracting from the merits of the present invention.

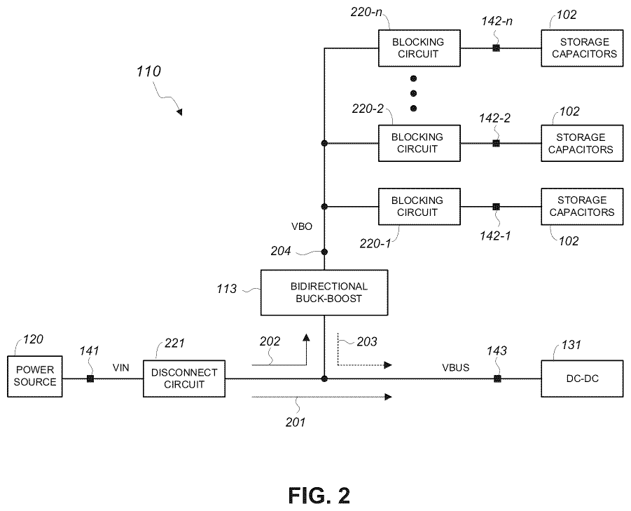

FIG. 2 shows a block diagram of the PMIC 110 in accordance with an embodiment of the present invention. In the example of FIG. 2, the PMIC 110 includes the bidirectional buck-boost converter 113, a disconnect circuit 221, and a plurality of blocking circuits 220 (i.e., 220-1, 220-2, . . . , 220-n). The operation of the aforementioned components of the PMIC 110 as described herein may be controlled by the controller 112 (shown in FIG. 1).

The power source 120 provides the input voltage VIN at the input pin 141 of the PMIC 110. During normal operation, the disconnect circuit 221 is configured to connect the input voltage VIN at the input pin 141 to the output pin 143 as the bus voltage VBUS (see arrow 201), which is received by the DC-DC converter circuit 131 of the application device 130 (shown in FIG. 1). Also during normal operation, the bidirectional buck-boost converter 113 receives the input voltage VIN (see arrow 202) by way of the disconnect circuit 221. The bidirectional buck-boost converter 113 operates as a boost converter during normal operation, using the input voltage VIN from the power source 120 as input voltage to generate, at a storage node 204, a voltage VBO that charges the plurality of sets of storage capacitors 102.

In the event of power loss, the disconnect circuit 221 is configured to disconnect the power source 120 from the PMIC 110, and thus from the DC-DC converter 131. Also during power loss, the bidirectional buck-boost converter 113 operates as a buck converter that uses the voltage VBO at the storage node 204, which is now from the charge stored in the sets of storage capacitors 102, as input voltage to generate the bus voltage VBUS (sec arrow 203), which is received by the DC-DC converter circuit 131 at the output pin 143.

Each storage pin 142 of the PMIC 110 has a separate blocking circuit 220 that connects a corresponding set of storge capacitors 102 to the PMIC 110. A blocking circuit 220 is normally in the ON state, i.e., connects a set of storage capacitors 102 to the PMIC 110. In the event of a failure in a set of storage capacitors 102, the corresponding blocking circuit 220 is configured to be in the OFF state, i.e., disconnects the failed set of storage capacitors 102 from the PMIC 110. In the example of FIG. 2, because all of the sets of storage capacitors 102 are connected to the same storage node 204, disconnecting a particular set of storage capacitors 102 from the PMIC 110 also disconnects that particular set of storage capacitors 102 from the other sets of storage capacitors 102.

A set of storage capacitors 102 is deemed to have failed when at least one storage capacitor in the set of storage capacitors 102 has failed, e.g., developed a short to ground. A failed set of storage capacitors 102 may be detected by sensing overcurrent through the line connecting the failed set of storage capacitors 102 to the PMIC 110. Because each set of storage capacitors 102 has a separate connection to the PMIC 110 by way of a separate pin 142, each set of storage capacitors 102 may be monitored for failure and a failed set of storage capacitors 102 may be separately disconnected from the PMIC 110 and from remaining, operational sets of storage capacitors 102. That is, operational sets of storage capacitors 102 will still be connected to the PMIC 110 to provide power loss protection. For example, a failure in the set of storage capacitors 102 connected to the storage pin 142-1 will cause the blocking circuit 220-1 to disconnect the set from the PMIC 110 and from the set of storage capacitors 102 connected to the storage pin 142-2. In that situation, the blocking circuit 220-2 will continue to connect its corresponding set of operational storage capacitors 102 to the PMIC 110.

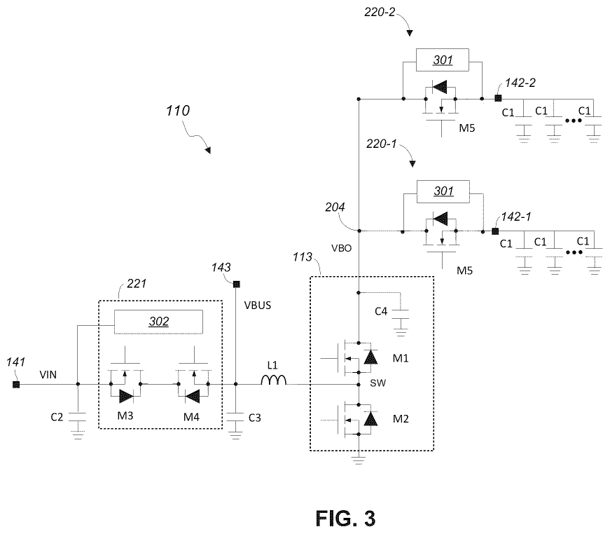

FIG. 3 shows a schematic diagram of the PMIC 110 in accordance with an embodiment of the present invention. Only two sets of storage capacitors C1 are shown in FIG. 3 for illustration purposes. The PMIC 110 comprises the disconnect circuit 221, the bidirectional buck-boost converter 113, a blocking circuit 220-1, and a blocking circuit 220-2.

In the example of FIG. 3, a decoupling capacitor C2 connects the input pin 141 to ground, and a capacitor C3 serves as an output capacitor at the output pin 143. The disconnect circuit 221 comprises transistors M3 and M4, which in one embodiment are metal-oxide semiconductor field-effect transistors (MOSFETs). The transistor M3 has a first terminal (e.g., source) that is connected to the input pin 141, and the transistor M4 has a first terminal (e.g., source) that is connected to the output pin 143. A second terminal (e.g., drain) of the transistor M3 is connected to a second terminal (e.g., drain) of the transistor M4. The third terminal (e.g., gate) of each of the transistors M3 and M4 receives a control signal for controlling switching of the transistors M3 and M4. The transistors M3 and M4 are both turned ON to connect the input voltage VIN at the input pin 141 to the output pin 143 as the bus voltage VBUS during normal operation. The transistors M3 and M4 are both turned OFF to disconnect the power source 120 (see FIG. 2) in the event of power loss.

In one embodiment, the disconnect circuit 221 includes a sense circuit 302 (e.g., voltage sense circuit) for detecting power loss at the input pin 141. The sense circuit 302 may control the third terminal (e.g., gate) of each the transistors M3 and M4 to keep them ON (i.e., closed) during normal operation or to turn them OFF (i.e., open) in the event of a power loss. The disconnect circuit 221 may be in accordance with the E-Fuse™ technology of Monolithic Power Systems, Inc., for example.

As can be appreciated the disconnect circuit 221 may also be implemented with a single transistor and/or with a separate sense circuit without detracting from the merits of the present invention. For example, the sense circuit 302 may provide a sense signal to the controller 112 (shown in FIG. 1) to indicate the condition of the input voltage VIN at the input pin 141. The input pin 141 may be connected to the output pin 143 by way of a single transistor. The controller 112 may keep the transistor ON during normal operation and turn the transistor OFF in the event of power loss. Other sensing and disconnect configurations may also be employed without detracting from the merits of the present invention.

In the example of FIG. 3, the bidirectional buck-boost converter 113 includes transistors M1 and M2, which in one embodiment are MOSFETs. A first terminal (e.g., source) of the transistor M1 is connected to a second terminal (e.g., drain) of the transistor M2 to form a switch node SW. A second terminal (e.g., drain) of the transistor M1 is connected to the storage node 204, and a first terminal (e.g., source) of the transistor M2 is connected to ground. The switch node SW is connected to the output pin 143 by way of an inductor L1. The third terminals (e.g., gates) of the transistors M1 and M2 are controlled by the controller 112 (shown in FIG. 1) to operate the transistors M1 and M2 to perform boost conversion during normal operation and to perform buck conversion during power loss. A decoupling capacitor C4 connects the storage node 204 to ground.

In the example of FIG. 3, the storage capacitors C1 of a set of storage capacitors C1 are connected in parallel. Each storage capacitor C1 has a first end that is connected to the storage node 204 by way of a blocking circuit 220 and a second end that is connected to ground. A blocking circuit 220 connects a set of storage capacitors C1 to the PMIC 110. In the example of FIG. 3, a blocking circuit 220 is connected in series between a storage pin 142 and the storage node 204.

In the example of FIG. 3, a blocking circuit 220 includes a transistor M5 (e.g., MOSFET) and a sense circuit 301. The transistor M5 has a first terminal (e.g., source) that is connected to a storage pin 142 and a second terminal (e.g., drain) that is connected to the storage node 204. The sense circuit 301 is configured to detect overcurrent (i.e., excessive, damaging current) through the transistor M5. The sense circuit 301 may be implemented using a sense transistor across the transistor M5 in a dual transistor sensing configuration. The sense circuit 301 may include a comparator that compares the sense current to a threshold to detect overcurrent. As can be appreciated, the sense circuit 301 may also be implemented using a sense resistor in series with the transistor M5 or other sensing configuration. A failed set of storage capacitors C1 may also be detected using other detection schemes without detracting from the merits of the present invention.

The sense circuit 301 may be configured to control the third terminal (e.g., gate) of the transistor M5 to turn the transistor M5 ON or OFF. The sense circuit 301 turns OFF the transistor M5 to disconnect the set of storage capacitors C1 from the storage node 204 in response to detection of overcurrent through the transistor M5; the sense circuit 301 otherwise keeps the transistor M5 ON. In other embodiments, the sense circuit 301 sends a sense signal to the controller 112, which controls the third terminal of the transistor M5 to turn the transistor M5 OFF when the sense signal indicates overcurrent; the controller 112 otherwise keeps the transistor M5 ON. Turning OFF the transistor M5 disconnects the corresponding set of storage capacitors C1 from the bidirectional buck-boost converter 113 and from the other set of storage capacitors C1.

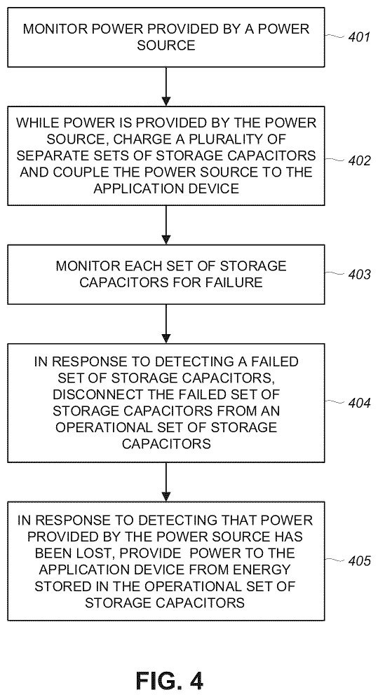

FIG. 4 shows a flow diagram of a method of providing power loss protection to an application device in accordance with an embodiment of the present invention. The method of FIG. 4 may be performed by the PMIC 110, for example.

In step 401, power provided by a power source is monitored at an input pin of a PMIC. In step 402, while power is being provided by the power source, the power source is connected to an application device and a plurality of sets of storage capacitors are charged using power from the power source. In one embodiment, a bidirectional buck-boost converter operates in boost mode to boost an input voltage from the power source to a higher voltage that is used to charge the sets of storage capacitors.

In step 403, each set of storage capacitors is monitored for failure. In one embodiment, current through a line connecting a set of storage capacitors to the PMIC is monitored for overcurrent, i.e. excessive current that can damage the PMIC, other sets of storage capacitors, or other circuits. Overcurrent from a set of storage capacitors indicates a failed set of storage capacitors.

In step 404, in response to detecting a failed set of storage capacitors, the failed set of storage capacitors is disconnected from an operational set of storage capacitors and from the PMIC. The operational set of storage capacitors remains connected to the PMIC.

In step 405, in response to detecting that power from the power source has been lost, the power source is disconnected from the PMIC. In that case, power to the application device is provided from energy stored in the operational set of storage capacitors.

While specific embodiments of the present invention have been provided, it is to be understood that these embodiments are for illustration purposes and not limiting. Many additional embodiments will be apparent to persons of ordinary skill in the art reading this disclosure.

For instance, in accordance with an alternative embodiment, during normal operation, the bidirectional buck-boost converter 113 may operate as a buck converter to step down the input voltage VIN to a lower voltage for charging the sets of storage capacitors 102. For example, the bidirectional buck-boost converter 113 may buck the input voltage VIN of 12V down to 5.5V (or alternatively 2.5V, 2.7V, 3.0V or 3.3V or other voltage values suitable for meeting application requirements), which is used to charge the sets of storage capacitors 102 during normal operation. For this exemplary situation, the sets of storage capacitors 102 may include super capacitors. During power loss, the bidirectional buck-boost converter 113 may operate as a boost converter that generates the bus voltage VBUS using energy stored in the sets of storage capacitors 102. For example, the bidirectional buck-boost converter 113 may boost the voltage provided by the sets of storage capacitors 102 from about 5.5V or alternatively other voltage values such as 2.5V, 2.7V, 3.0V or 3.3V (which decreases as the energy stored in the sets of storage capacitors 102 is depleted) to a voltage of about 6V to 12V, which is provided at the output pin 143 as the bus voltage VBUS. Specific current or voltage values described in the present disclosure are just for examples to help understand embodiments of the present invention and are not intended to be limiting.

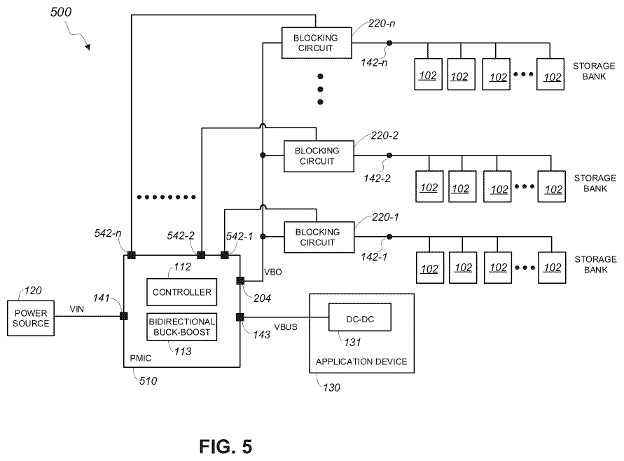

FIG. 5 shows a block diagram of a system 500 with power loss protection in accordance with an embodiment of the present invention. Similar as the example of FIG. 1, in the example of FIG. 5, the system 500 may include the power source 120, a power management integrated circuit (PMIC) 510, and the application device 130.

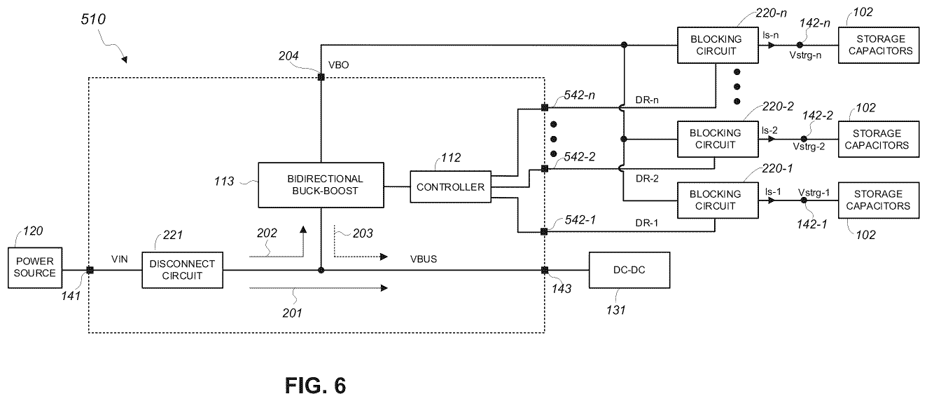

FIG. 6 shows a block diagram of the PMIC 510 in accordance with an embodiment of the present invention. The PMIC 510 as illustrated in FIG. 5 may be considered as an alternative example from the PMIC 110 as shown in the example of FIG. 2.

One of ordinary skill in the art would understand that substantial descriptions related to the embodiments of FIG. 1 to FIG. 4 may apply to the embodiments of FIG. 5 and FIG. 6 except that in the embodiments of FIG. 5 and FIG. 6, the plurality of blocking circuits 220 (i.e., 220-1, 220-2, . . . , 220-n) may be placed outside the PMIC 510. That is to say, in the exemplary embodiments of FIG. 5 and FIG. 6, the plurality of blocking circuits 220 (i.e., 220-1, 220-2, . . . , 220-n) may not be necessarily integrated in the PMIC 510. Correspondingly, the plurality of storage pins 142 (e.g., illustrated as an example including the storage pins 142-1 to 142-n) in the examples of FIG. 1 and FIG. 2 may now not formed on the PMIC 510 in the examples of FIG. 5 and FIG. 6, but instead become a plurality of storage nodes 142 (e.g., illustrated as an example including the storage nodes 142-1 to 142-n in FIG. 5 and FIG. 6) placed off and outside the PMIC 510.

Referring to the system 500 as illustrated in FIG. 5, the PMIC 510 comprises electrical circuits that are packaged together as an integrated circuit (IC) chip. In the example of FIG. 5, the PMIC 510 may include a plurality of pins that may include an input pin 141, an output pin 143, a storage pin 204, and a plurality of control pins 542 (i.e., 542-1, 542-2, . . . , 542-n). Pins that are not relevant to the present disclosure have been omitted in the interest of clarity. For the examples of FIG. 5 and FIG. 6, descriptions related to the power source 120, the input pin 141, the output pin 143, and the application device 130 are similar or the same as those described with reference to FIG. 1 and FIG. 2, and will not be repeated here as can be understood by persons of ordinary skill in the art.

In the example of FIG. 5, each single storage node 142 may be connected to an energy storage bank, which in one embodiment is a set of storage capacitors 102 that are connected in parallel. Different from the PMIC 110, for the PMIC 510 as shown in FIG. 5 and FIG. 6, the storage node 204 may be embodied as a storage pin that is still labeled and referenced with 204 for simplicity of description and understanding. The PMIC 510, which may have the storage pin 204, may be adapted to be configured to work with two or more energy storage banks. For instance, the PMIC 510 may be adapted to be coupled to a plurality of energy storage banks via a plurality of blocking circuits 220 (i.e., 220-1, 220-2, . . . , 220-n). That is, the storage pin 204 may be coupled to a first energy storage bank for instance including a first set of storage capacitors 102 through a first blocking circuit 220-1, the storage pin 204 may be coupled to a second energy storage bank for instance including a second set of storage capacitors 102 through a second blocking circuit 220-2, etc. The PMIC 510 may be configured to be adapted to support coupling to or working with at least two separate sets of storage capacitors 102, with each of the sets of storage capacitors 102 being separately connected to its own corresponding blocking circuit 220 which may have a first terminal adapted to be connected to the storage pin 204 and a second terminal adapted to be connected to the corresponding set of storage capacitors 102 at a corresponding one of the plurality of storage nodes 142. Additional sets of storage capacitors 102, with each set being coupled to the storage pin 204 of the PMIC 510 via a corresponding blocking circuit 220, may be connected to the PMIC 510 to meet specific application device requirements. Therefore, it is apparent to one of ordinary skill in the art that throughout the present disclosure, n used in connection with the labels may be a variable integer greater than 1.

Similar as the PMIC 110, the PMIC 510 in accordance with an exemplary embodiment may include the controller 112 and the bidirectional buck-boost converter 113. The bidirectional buck-boost converter 113 may include a DC-DC converter that may be adapted to be operated as a buck converter in one direction or a boost converter in an opposite direction.

In accordance with an exemplary embodiment, during normal operation, the bidirectional buck-boost converter 113 may use the input voltage VIN from the power source 120 to charge the sets of storage capacitors 102 that are coupled to the storage pin 204. In one embodiment, during normal operation, the bidirectional buck-boost converter 113 may be configured to convert the input voltage VIN received at the input pin 141 from the power source 120 to a storage voltage VBO at the storage pin 204 that may be adapted for charging the sets of storage capacitors 102. In accordance with an exemplary embodiment, during power loss, the bidirectional buck-boost converter 113 may be configured to generate the bus voltage VBUS using energy stored in the sets of storage capacitors 102 that are coupled to the storage pin 204. In one embodiment, during power loss, the bidirectional buck-boost converter 113 may be configured to convert the storage voltage VBO at the storage pin 204 to the bus voltage VBUS provided at the output pin 143 that may be adapted to supply the application device 130, for instance allowing the DC-DC converter circuit 131 to power the circuits of the application device 130, at least for a sufficient time to allow shutdown procedures to complete (e.g., saving to NVRAM) in the event of power loss. The length of time that the bus voltage VBUS can be provided by the PMIC 510 in the event of power loss depends on the energy storage capacity of the sets of storage capacitors 102.

In accordance with an exemplary embodiment, during normal operation, the bidirectional buck-boost converter 113 may operate as a boost converter to step up the input voltage VIN to a higher voltage VBO for charging the sets of storage capacitors 102. For example, the bidirectional buck-boost converter 113 may boost the input voltage VIN of 12V up to 30V as the storage voltage VBO, which may be used to charge the sets of storage capacitors 102 during normal operation. During power loss, the bidirectional buck-boost converter 113 may operate as a buck converter that generates the bus voltage VBUS using energy stored in the sets of storage capacitors 102. For example, the bidirectional buck-boost converter 113 may buck the storage voltage VBO stored at the storage pin 204 and provided by the sets of storage capacitors 102 from about 30V (which decreases as the energy stored in the sets of storage capacitors 102 is depleted in the event of power loss) to about 10V, which is provided at the output pin 143 as the bus voltage VBUS.

Persons of ordinary skill in the art would understand that the examples provided here are just for helping to better understand various embodiments of the present invention and are not intended to be limiting, many modifications may be apparent and do not depart from the spirit and scope of the present disclosure. For instance, in accordance with an alternative exemplary embodiment, during normal operation, the bidirectional buck-boost converter 113 may operate as a buck converter to step down the input voltage VIN to a lower voltage VBO for charging the sets of storage capacitors 102. For example, the bidirectional buck-boost converter 113 may buck the input voltage VIN of 12V up to 5.5V (or alternatively 2.5V, 2.7V, 3.0V or 3.3V or other voltage values suitable for meeting application requirements) as the storage voltage VBO, which may be used to charge the sets of storage capacitors 102 during normal operation. For this exemplary situation, the sets of storage capacitors 102 may include super capacitors. During power loss, the bidirectional buck-boost converter 113 may operate as a boost converter that generates the bus voltage VBUS using energy stored in the sets of storage capacitors 102. For example, the bidirectional buck-boost converter 113 may boost the storage voltage VBO stored at the storage pin 204 and provided by the sets of storage capacitors 102 from about 5.5V or alternatively other voltage values such as 2.5V, 2.7V, 3.0V or 3.3V (which decreases as the energy stored in the sets of storage capacitors 102 is depleted in the event of power loss) to a voltage of about 6V to 12V, which is provided at the output pin 143 as the bus voltage VBUS.

In accordance with an exemplary embodiment, each single control pin 542 of the PMIC 510 may be adapted to be configured to control a corresponding one of the plurality of blocking circuits 220. Each set of storage capacitors 102 may be connected to a separate blocking circuit 220 that may allow a failed set of storage capacitors 102 to be disconnected from the PMIC 510 without impacting operational (i.e., nonfailing) sets of storage capacitors 102. For example, a failed storage capacitor 102 can create a short circuit to ground. By opening a corresponding blocking circuit 220, the set with the failed storage capacitor (i.e., the failed set of storage capacitors 102) can be disconnected from the PMIC 510, and thus from remained operational sets of storage capacitors 102. This advantageously allows the PMIC 510 to continue to operate and provide some level of power loss protection, using stored energy from operational sets of storage capacitors 102 that are still connected to the PMIC 510, even in the event of a storage capacitor failure.

The PMIC 510 may further include the controller 112 for controlling the operation of the bidirectional buck-boost converter 113, a disconnect circuit, the blocking circuits, and other components of the PMIC 510. The controller 112 may be configured to control the bidirectional buck-boost converter 113 by pulse width modulation (PWM) to operate in buck mode or boost mode operation using conventional algorithms. The controller 112 may generate control signals to control switching of transistors, etc. so that the PMIC 510 operates as described herein. The controller 112 may receive sense signals, such as sense currents/voltages to detect overcurrent, power loss, etc. The controller 112 may be configured to process and respond to received sense signals using comparators, state machines, logic circuits, etc. in accordance with conventional algorithms without detracting from the merits of the present invention.

Now referring to the example shown in FIG. 6, the PMIC 510 as illustrated in FIG. 6 may be considered as an alternative example from the PMIC 110 as shown in the example of FIG. 2. In the example of FIG. 6, the PMIC 510 may include the bidirectional buck-boost converter 113 and the disconnect circuit 221. The operation of the aforementioned components of the PMIC 510 as described herein may be controlled by the controller 112.

The power source 120 provides the input voltage VIN at the input pin 141 of the PMIC 510. During normal operation, the disconnect circuit 221 is configured to connect the input voltage VIN at the input pin 141 to the output pin 143 as the bus voltage VBUS (see arrow 201), which is received by the DC-DC converter circuit 131 of the application device 130 (shown in FIG. 1). Also during normal operation, the bidirectional buck-boost converter 113 receives the input voltage VIN (see arrow 202) by way of the disconnect circuit 221. The bidirectional buck-boost converter 113 may operate as a boost converter in an example (or as a buck converter in an alternative example) during normal operation, using the input voltage VIN from the power source 120 as input voltage to generate, at the storage pin 204, the storage voltage VBO that may be adapted to be configured to charge the plurality of sets of storage capacitors 102 that are coupled to the storage pin 204.

In the event of power loss, the disconnect circuit 221 is configured to disconnect the input pin 141 from the output pin 143, and thus disconnect the power source 120 from the DC-DC converter 131. Also during power loss, the bidirectional buck-boost converter 113 may operate as a buck converter in an example (or as a boost converter in an alternative example) that uses the storage voltage VBO at the storage pin 204, which may be adapted to be powered from the charge stored in the sets of storage capacitors 102 in the event of power loss, as input voltage to generate the bus voltage VBUS (see arrow 203), which is received by the DC-DC converter circuit 131 at the output pin 143.

In the exemplary embodiments of FIG. 5 and FIG. 6, the storage pin 204 may be adapted to be coupled to a plurality sets of storage capacitors 102. Each set of storge capacitors 102 may be coupled to the PMIC 510 at the storage pin 204 via a corresponding blocking circuit 220. A blocking circuit 220 is normally in the ON state, i.e., connects a set of storage capacitors 102 to the PMIC 510. In the event of a failure in a set of storage capacitors 102, the corresponding blocking circuit 220 is configured to be in the OFF state, i.e., disconnects the failed set of storage capacitors 102 from the PMIC 510. In the example of FIG. 6, because all of the sets of storage capacitors 102 are coupled to the same storage pin 204, disconnecting a particular set of storage capacitors 102 from the PMIC 510 also disconnects that particular set of storage capacitors 102 from the other sets of storage capacitors 102.

In accordance with various embodiments of the present disclosure, for instance, either in the exemplary embodiments illustrated in FIG. 1 and FIG. 2 or in the exemplary embodiments illustrated in FIG. 5 and FIG. 6, the PMIC 110 or the PMIC 510 may be adapted to separately control each set of storage capacitors 102 to be connected to the PMIC or to be disconnected from the PMIC. For instance, as has been described above with reference to the PMIC 110 and will be described here again with further reference to the PMIC 510, in an embodiment, the PMIC 110 or the PMIC 510 may be adapted to control each set of storage capacitors 102 to be connected to the PMIC (110 or 510) by controlling the corresponding blocking circuit 220 to be at the ON state or control each set of storage capacitors 102 to be disconnected from the PMIC (110 or 510) by controlling the corresponding blocking circuit 220 to be at the OFF state. That is, the PMIC 110 or the PMIC 510 may be adapted to be configured to separately control each blocking circuit 220 to be at the ON state to connect a corresponding set of storage capacitors 102 to the PMIC (110 or 510), or to be at the OFF state to disconnect the corresponding set of storage capacitors 102 from the PMIC (110 or 510).

Persons of ordinary skill in the art would understand that for embodiments of PMIC such as the PMIC 110 with the plurality of blocking circuits 220 (i.e., 220-1, 220-2, . . . , 220-n) integrated inside the IC chip (i.e., the PMIC such as the PMIC 110), the PMIC (such as the PMIC 110) may provide a control signal to each of the plurality of blocking circuits 220 inside the PMIC to control ON or OFF of a corresponding blocking circuit 220. For embodiments of PMIC such as the PMIC 510 with the plurality of blocking circuits 220 (i.e., 220-1, 220-2, . . . , 220-n) outside the IC chip (i.e., the PMIC such as the PMIC 510), the PMIC such as the PMIC 510 may be configured to provide a control signal to each of the plurality of blocking circuits 220 outside the PMIC to control ON or OFF of a corresponding blocking circuit 220.

In accordance with an exemplary embodiment, the PMIC 510 may be configured to provide a control signal DR at each of the plurality of control pins 542 (i.e., 542-1, 542-2, . . . , 542-n) which may be adapted to control a corresponding blocking circuit 220. That is, the PMIC 510 may be configured to provide a plurality of control signals DR (i.e., DR-1, DR-2, . . . , DR-n) at the plurality of control pins 542 (i.e., 542-1, 542-2, . . . , 542-n) with each control pin 542 adapted to output a corresponding control signal DR for controlling a corresponding blocking circuit 220. For example, the PMIC 510 may be configured to provide a first control signal DR-1 at a first control pin 542-1 that may be adapted to be coupled to a first blocking circuit 220-1 to control ON or OFF of the first blocking circuit 220-1 to control connection or disconnection of a first set of storage capacitors 102 to or from the PMIC 510, the PMIC 510 may further be configured to provide a second control signal DR-2 at a second control pin 542-2 that may be adapted to be coupled to a second blocking circuit 220-2 to control ON or OFF of the second blocking circuit 220-2 to control connection or disconnection of a second set of storage capacitors 102 to or from the PMIC 510, etc. The PMIC 510 may be configured to be adapted to support working with at least two separate sets of storage capacitors 102. Additional sets of storage capacitors 102 may be coupled to the PMIC 510 to meet specific application device requirements.

In accordance with an exemplary embodiment as shown in FIG. 5 and FIG. 6, each one of the plurality of blocking circuits 220 (i.e., 220-1, 220-2, . . . , 220-n) may have a first terminal adapted to be connected to the storage pin 204, a second terminal adapted to be connected to a corresponding set of storage capacitors 102 at a corresponding one of the plurality of storage nodes 142, and a control terminal adapted to be connected to a corresponding one of the plurality of control pins 542 (i.e., 542-1, 542-2, . . . , 542-n). Each single blocking circuit 220 may be adapted to be controlled ON or OFF through providing a control signal DR to its own control terminal. Each single blocking circuit 220 may allow signal to be coupled or transmitted between its first terminal and its second terminal when being controlled ON (or in the ON state), and may block signal coupling or transmission between its first terminal and its second terminal when being controlled OFF (or in the OFF state). In an embodiment, each single blocking circuit 220 may include a controllable pass device or a controllable switch device that may have a first terminal, a second terminal and a control terminal and that may be configured to open or close a signal path between the first terminal and second terminal by providing a control signal to the control terminal. In an embodiment, each single blocking circuit 220 may be packaged in a single IC chip. For instance, a load switch IC or a smart switch IC generally including a switching device and a driver for driving the switching device may be used as a single blocking circuit 220. To provide an example, each single blocking circuit 220 may be implemented by a load switch IC or a smart switch IC such as the MP5087 commercially-available from Monolithic Power Systems, Inc. In an alternative embodiment, two or more blocking circuits 220 may be co-packaged together in one IC chip. For instance, a load switch IC or a smart switch IC including two or more switching devices and associated drivers to drive the two or more switching devices adapted to provide two or more controllable signal paths with each controllable signal path being available to be separately controlled open or close (or being available to be switched ON or OFF) may be used to implement two or more of the blocking circuits 220. To provide an example, every two blocking circuits 220 may be implemented by a load switch IC or a smart switch IC such as the MP5092 commercially-available from Monolithic Power Systems, Inc. One of ordinary skill in the art would understand that many variants of the blocking circuits 220 may be available and the present disclosure apparently encompass those variants.

A set of storage capacitors 102 is deemed to have failed when at least one storage capacitor in the set of storage capacitors 102 has failed, e.g., developed a short to ground. In an embodiment, a failed set of storage capacitors 102 may be detected by sensing overcurrent through a separate line or a component such as the blocking circuit 220 connecting the failed set of storage capacitors 102 to the PMIC 510. In an alternative embodiment, a failed set of storage capacitors 102 may be detected by sensing an undervoltage across the failed set of storage capacitors for instance by sensing an undervoltage at the storage node 142 connecting the failed set of storage capacitors during normal operation. As is well known by persons of ordinary skill in the art, an overcurrent may refer to a current goes up to reach or exceed an overcurrent threshold value. An undervoltage may refer to a voltage goes down to reach or below an undervoltage threshold value. Thus, for each j varies from 1 to n, sensing an overcurrent through the separate line or the component (e.g., the blocking circuit 220-j) connecting a set of storage capacitors 102 may be implemented by detecting whether a current Is-j flowing through the line or the component connecting the set of storage capacitors 102 reaches or exceeds an overcurrent threshold value. It may be determined that an overcurrent is sensed or detected once the current Is-j flowing through the line or the component connecting the set of storage capacitors 102 reaches or exceeds the overcurrent threshold value, thereby indicating that the set of storage capacitors 102 connected to the corresponding storage node 142-j is failed. Alternatively, for each j varies from 1 to n, sensing an undervoltage across a set of storage capacitors 102 or at the corresponding storage node 142-j connecting the set of storage capacitors 102 during normal operation may be implemented by detecting whether a voltage Vstrg-j across the set of storage capacitors 102 or at the corresponding storage node 142-j falls to or below an undervoltage threshold value during normal operation. It may be determined that an undervoltage is sensed or detected once the voltage Vstrg-j across the set of storage capacitors 102 or at the corresponding storage node 142-j falls to or below an undervoltage threshold value during normal operation, thereby indicating that the set of storage capacitors 102 connected to the corresponding storage node 142-j is failed.

Because each set of storage capacitors 102 has a separate connection to the PMIC 510 by way of a separate storage node 142 and an associated blocking circuit 220 that can be separately controlled independent from other blocking circuits 220, each set of storage capacitors 102 may be monitored for failure and a failed set of storage capacitors 102 may be separately disconnected from the PMIC 510 and from remaining, operational sets of storage capacitors 102. That is, operational sets of storage capacitors 102 will still be connected to the PMIC 510 to provide power loss protection. For example, a failure in the set of storage capacitors 102 connected to the storage node 142-1 will cause the associated blocking circuit 220-1 to disconnect the set from the PMIC 510 and from the set of storage capacitors 102 connected to the storage node 142-2. In that situation, the blocking circuit 220-2 will continue to connect its corresponding set of operational storage capacitors 102 to the PMIC 510.

In accordance with an embodiment of the present invention, the PMIC 510 may include the controller 112 that may be configured to control the operation of a plurality of components (e.g., including but not limited to the bidirectional buck-boost converter 113, the disconnect circuit 221 etc.) of the PMIC 510 as described herein. In an embodiment, the controller 112 may further be configured to generate the plurality of control signals DR (i.e., DR-1, DR-2, . . . , DR-n) that are respectively provided at the plurality of control pins 542 (i.e., 542-1, 542-2, . . . , 542-n). In an embodiment, the controller 112 may be configured to generate the plurality of control signals DR (i.e., DR-1, DR-2, . . . , DR-n) based on signals indicative of failed sets of storage capacitors 102, such as signals indicative of overcurrent through the line or the component such as the blocking circuit 220 connecting each failed set of storage capacitors 102 to the PMIC 510 or signals indicative of undervoltage across each failed set of storage capacitors 102 (or undervoltage at the corresponding storage node 142 connecting each set of failed storage capacitors 102) during normal operation.

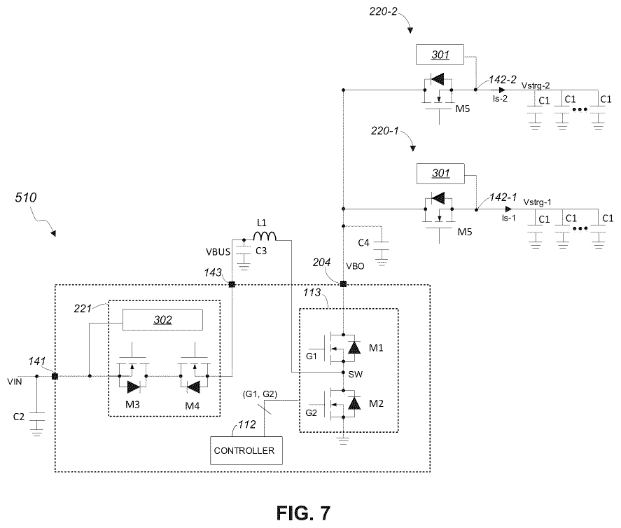

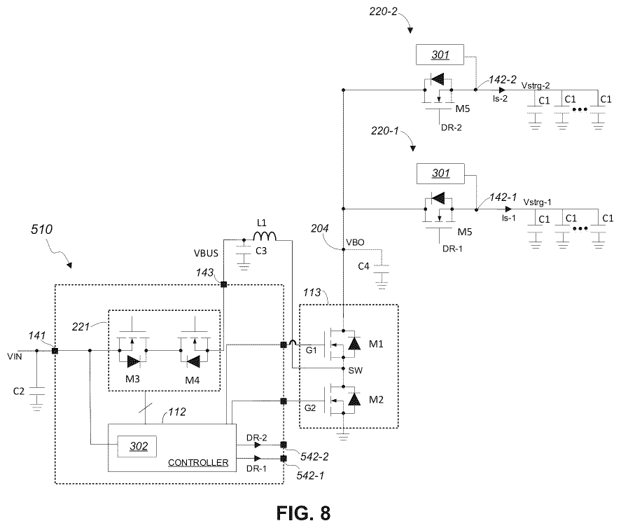

FIG. 7 shows a schematic diagram of the PMIC 510 in accordance with an embodiment of the present invention. FIG. 8 shows a schematic diagram of the PMIC 510 in accordance with another embodiment of the present invention. Only two sets of storage capacitors C1 are shown in FIG. 7 and FIG. 8 for illustration purposes. The PMIC 510 may comprise the disconnect circuit 221 and the controller 112. In an embodiment, the PMIC 510 may have the bidirectional buck-boost converter 113 integrated on the PMIC 510 IC chip as illustrated in FIG. 7. In an alternative embodiment, the bidirectional buck-boost converter 113 may not be integrated on the PMIC 510 IC chip and instead may be placed off and outside the PMIC 510 as illustrated in FIG. 8. The blocking circuit 220-1 and the blocking circuit 220-2 may be placed outside the PMIC 510.

In the examples of FIG. 7 and FIG. 8, a decoupling capacitor C2 connects the input pin 141 to ground, and a capacitor C3 serves as an output capacitor at the output pin 143. The capacitors C2 and C3 may be provided from outside of the PMIC 510 as shown or may be integrated on the PMIC 510. The disconnect circuit 221 comprises transistors M3 and M4, which in one embodiment are metal-oxide semiconductor field-effect transistors (MOSFETs). The transistor M3 has a first terminal (e.g., source) that is connected to the input pin 141, and the transistor M4 has a first terminal (e.g., source) that is connected to the output pin 143. A second terminal (e.g., drain) of the transistor M3 is connected to a second terminal (e.g., drain) of the transistor M4. The third terminal (e.g., gate) of each of the transistors M3 and M4 receives a control signal for controlling switching of the transistors M3 and M4. The transistors M3 and M4 are both turned ON to connect the input voltage VIN at the input pin 141 to the output pin 143 as the bus voltage VBUS during normal operation. The transistors M3 and M4 are both turned OFF to disconnect the power source 120 (see FIG. 2 or FIG. 6) in the event of power loss.

In one embodiment, the PMIC 510 may include a sense circuit 302 (e.g., voltage sense circuit) for detecting power loss at the input pin 141. The sense circuit 302 may control the third terminal (e.g., gate) of each of the transistors M3 and M4 to keep them ON (i.e., closed) during normal operation or to turn them OFF (i.e., open) in the event of a power loss. In an embodiment, the sense circuit 302 may be implemented as part of the disconnect circuit 221 as illustrated in FIG. 7. The disconnect circuit 221 may be in accordance with the E-Fuse™ technology of Monolithic Power Systems, Inc., for example. In an alternative embodiment, the sense circuit 302 may be implemented as part of the controller 112 as illustrated in FIG. 8 and thus, for this situation, the controller 112 may control the third terminal (e.g., gate) of each of the transistors M3 and M4 as described above (i.e., to keep the transistors M3 and M4 ON during normal operation and turn them OFF in the event of power loss).

As can be appreciated the disconnect circuit 221 may also be implemented with a single transistor and with a separate sense circuit or without the sense circuit without detracting from the merits of the present invention. For example, the sense circuit 302 may provide a sense signal to the controller 112 to indicate the condition of the input voltage VIN at the input pin 141. The input pin 141 may be connected to the output pin 143 by way of a single transistor. The controller 112 may keep the transistor ON during normal operation and turn the transistor OFF in the event of power loss. Other sensing and disconnect configurations may also be employed without detracting from the merits of the present invention.

In the examples of FIG. 7 and FIG. 8, the bidirectional buck-boost converter 113 is illustrated to include transistors M1 and M2, which in one embodiment are MOSFETs. The transistors M1 and M2 may be integrated in the PMIC 510 in an embodiment (see FIG. 7) or may be placed outside the PMIC 510 in an alternative embodiment (see FIG. 8). The PMIC 510 may be configured to provide one or more driving signals that are adapted to control the bidirectional buck-boost converter 113 to operate as described in accordance with various exemplary embodiments in the present disclosure. For instance, the PMIC 510 may include the controller 112 that may be configured to provide the one or more driving signals to control the converter 113. In the examples as illustrated in FIG. 7 and FIG. 8, the controller 112 may provide a first driving signal G1 and a second driving signal G2 to respectively control the transistors M1 and M2 of the converter 113. For embodiments where the converter 113 may not be integrated in the PMIC 510, the PMIC 510 may further have one or more driving pins configured to respectively provide the one or more driving signals. For instance, in the example as illustrated in FIG. 8, the PMIC 510 may have a first driving pin configured to provide the first driving signal G1 adapted to control the transistor M1 and a second driving pin configured to provide the second driving signal G2 adapted to control the transistor M2. In the examples of FIG. 7 and FIG. 8, a first terminal (e.g., source) of the transistor M1 is connected to a second terminal (e.g., drain) of the transistor M2 to form a switch node SW. A second terminal (e.g., drain) of the transistor M1 is connected to the storage pin 204 (as shown in FIG. 7) or the storage node 204 (as shown in FIG. 8), and a first terminal (e.g., source) of the transistor M2 is connected to ground. The switch node SW is connected to the output pin 143 by way of an inductor L1. The third terminals (e.g., gates) of the transistors M1 and M2 are controlled by the controller 112 (which for instance may provide the driving signals G1 and G2) to operate the transistors M1 and M2 to perform boost conversion (or buck conversion in an alternative embodiment) during normal operation and to perform buck conversion (or boost conversion in an alternative embodiment) during power loss. A decoupling capacitor C4 may be provided to connect the storage pin 204 to ground.

In the examples of FIG. 7 and FIG. 8, the storage capacitors C1 of a set of storage capacitors C1 are connected in parallel. Each storage capacitor C1 has a first end that is connected to the storage pin 204 of the PMIC 510 by way of a blocking circuit 220 and a second end that is connected to ground. A blocking circuit 220 connects a set of storage capacitors C1 to the PMIC 510. In the example of FIG. 7, a blocking circuit 220 is connected in series between a storage node 142 and the storage pin 204 of the PMIC 510. In the example of FIG. 8, a blocking circuit 220 is connected in series between a storage node 142 and the storage node 204 which is coupled to the PMIC 510 by way of the converter 113.

In the examples of FIG. 7 and FIG. 8, a blocking circuit 220 may include a transistor M5 (e.g., a MOSFET) and a sense circuit 301. In an embodiment, the blocking circuit 220 may be in accordance with the load switch or smart switch technology as described with reference to FIG. 5 and FIG. 6. Monolithic Power Systems, Inc. provides commercially-available load switch or smart switch that may be used as the blocking circuit 220, for example. To provide an example, each single blocking circuit 220 may be implemented by a load switch IC or a smart switch IC such as the MP5087 commercially-available from Monolithic Power Systems, Inc. To provide an alternative exemple, every two blocking circuits 220 may be implemented by a load switch IC or a smart switch IC such as the MP5092 commercially-available from Monolithic Power Systems, Inc. The transistor M5 in each single blocking circuit 220 has a first terminal (e.g., drain) that is connected to the storage pin 204 as shown in FIG. 7 (or the storage node 204 as shown in FIG. 8) and a second terminal (e.g., source) that is connected to a storage node 142. In an embodiment, the sense circuit 301 may be configured to detect overcurrent (i.e., the current Is-1 or Is-2 being excessive, damaging current up to or above an overcurrent threshold) through the transistor M5. To provide an example, the sense circuit 301 may be implemented using a sense transistor across the transistor M5 in a dual transistor sensing configuration. To provide another example, the sense circuit 301 may include a comparator that compares the sense current to a threshold (i.e., the overcurrent threshold) to detect overcurrent. As can be appreciated, the sense circuit 301 may also be implemented using a sense resistor in series with the transistor M5 or other sensing configuration. A failed set of storage capacitors C1 may also be detected using other detection schemes without detracting from the merits of the present invention. For instance, in an alternative embodiment, the sense circuit 301 may be configured to detect undervoltage (i.e., sharp voltage dropping to or below an undervoltage threshold) of a voltage Vstrg (e.g., either Vstrg-1 or Vstrg-2 in the examples of FIG. 7 and FIG. 8) across the failed set of storage capacitors C1.

The sense circuit 301 may be configured to control the third terminal (e.g., gate) of the transistor M5 to turn the transistor M5 ON or OFF. The sense circuit 301 turns OFF the transistor M5 to disconnect the set of storage capacitors C1 from the storage pin 204 in response to detection of overcurrent through the transistor M5 or undervoltage across the set of storage capacitors C1; the sense circuit 301 otherwise keeps the transistor M5 ON. For this situation, the controller 112 (and thus the PMIC 510) may not need to provide the control signals DR to control the blocking circuits 220, and as a result, the PMIC 510 may not need to have the plurality of control pins 542 as illustratively shown in the example of FIG. 7. In other embodiments, the sense circuit 301 may send a sense signal to the controller 112, which may provide the control signals DR (e.g., DR-1, DR-2 in the illustrative example of FIG. 8) for controlling the third terminal of the transistor M5 to turn the transistor M5 OFF when the sense signal indicates overcurrent or undervoltage; the controller 112 otherwise keeps the transistor M5 ON. Turning OFF the transistor M5 disconnects the corresponding set of storage capacitors C1 from the bidirectional buck-boost converter 113 and from the other set of storage capacitors C1.

Now referring back to FIG. 4 showing the flow diagram of the method of providing power loss protection to an application device, the method of FIG. 4 may alternatively be performed by the PMIC 510, for example. Substantial descriptions related to the method steps do not change. It is apparent to one of ordinary skill in the art that additional alternatives performing the method with the PMIC 510 are obvious and do not detract from the merits of the present invention. For instance, in one embodiment, in step 402, a bidirectional buck-boost converter operates in buck mode to step down an input voltage from the power source to a lower voltage may be used to charge the sets of storage capacitors as an alternative example. In one embodiment, in step 403, current through a line or a component (such as the blocking circuit) connecting a set of storage capacitors to the PMIC is monitored for overcurrent, i.e. excessive current that can damage the PMIC, other sets of storage capacitors, or other circuits. Overcurrent from a set of storage capacitors indicates a failed set of storage capacitors. As an alternative example, voltage across a set of storage capacitors may be monitored for undervoltage, i.e., voltage across the set of storage capacitors falls to or below an undervoltage threshold value during normal operation. Undervoltage from a set of storage capacitors indicates a failed set of storage capacitors in this alternative example. In step 405, if a power loss event has been detected (i.e., it is detected that the power source has been lost), in one embodiment, a bidirectional buck-boost converter operates in buck mode (or alternatively operates in boost mode in another embodiment) may be used to convert energy stored in the operational set of storage capacitors to a bus voltage to supply the application device.

The advantages of the various embodiments of the present invention are not confined to those described above. These and other advantages of the various embodiments of the present invention will become more apparent upon reading the whole detailed descriptions and studying the various figures of the drawings. One of ordinary skill in the art would understand that many modifications and variants may be apparent and obvious upon reading the descriptions and studying the various figures of drawings of the exemplary embodiments of the present invention provided herein and do not detract from the merits of the present invention. Many of the elements of one embodiment may be combined with other embodiments in addition to or in lieu of the elements of the other embodiments.

What is claimed is:

1. An integrated circuit (IC) chip for providing power loss protection, the IC chip comprising:
an input pin, adapted to be configured to receive an input voltage from a power source;
an output pin, adapted to be configured to provide a bus voltage;
a disconnect circuit, coupled between the input pin and the output pin and configured to connect the input voltage at the input pin to the output pin in a normal operation when the power source provides the input voltage, and to disconnect the input pin from the output pin in an event of power loss when the power source no longer provides the input voltage; and
a controller, configured to provide one or more driving signals adapted to operate a converter circuit to charge a plurality of sets of storage capacitors during the normal operation and to provide the bus voltage from energy stored in at least one operational set of storage capacitors of the plurality of sets of storage capacitors in the event of power loss.
